(19) United States
(12) Patent Application Publication
(10) Pub. No.: US 2007/0063017 A1
(43) Pub. Date: Mar. 22, 2007

(54) System and method for securely making payments and deposits

(76) Inventors: Yaofei Chen, Harrison, NJ (US); Chunqi Han, San Jose, CA (US)

Correspondence Address: FORTUNE LAW GROUP LLP, 100 CENTURY CENTER COURT, SUITE 315, SAN JOSE, CA, 95112, US

(21) Appl. No.: 11/232,487

(22) Filed: Sep. 21, 2005

(51) Int. Cl. G07F 19/00; G06K 5/00; G06Q 40/00

(52) U.S. Cl. 235/379; 235/380; 705/44

(57) ABSTRACT

A system and method for securely making payments and deposits is disclosed. A method for securely and synchronously making a payment includes the steps of submitting a transaction request to a transaction center, the transaction request including details of a transaction between a customer and a third party, confirming the transaction request with the customer by communicating with a customer securely identifiable device, submitting the transaction request for approval, and paying the third party. A method of securely and synchronously making a deposit includes the steps of submitting a deposit request from a depositor to a transaction center, confirming an authorization request with the depositor by communicating with a customer securely identifiable device, receiving an authorization from the depositor, and depositing a deposit amount in a third party receiver account. Secure and asynchronous systems and methods are also disclosed.

### FIELD OF THE INVENTION

The present invention relates generally to payment systems and more particularly to a system and method for securely making payments and deposits.

### BACKGROUND OF THE INVENTION

The use of currency in making payments is rapidly being replaced with the use of payment cards such as credit and debit cards. Use of such cards typically includes the exchange of information between a consumer's bank or credit card issuer and a merchant's bank over networks managed either by regional payment providers or global card organizations. While various techniques may be employed to secure this exchange of information, customers are increasingly wary of their personal information being intercepted by identity thieves.

A conventional credit card transaction is shown in FIG. 1 and shows the opportunities an identity thief has of making fraudulent transactions without the customer's knowledge. Parties to the transaction may include the customer 100, the merchant 110, an acquirer 120, an association 130 and the credit card issuer 140. In order to affect an exemplary purchase totaling $100 by the customer 100 from the merchant 110 using a credit card, the transaction is submitted to the acquirer 120 by the merchant 110 including an authorization request. The submission process conventionally includes a data communication between the merchant 110 and the acquirer 120 using a wired network.

Upon receiving the submission from the merchant 110, the acquirer 120 submits the transaction to the association 130 which in turn submits the transaction to the issuer 140. Each transaction submission includes an authorization request. In the case where the issuer 140 approves the transaction and authorization request, the issuer 140 sends an approval to the association 130 and a reimbursement less a fee of $1.59. The reimbursement may be affected by means of an electronic funds transfer.

The association 130 in turn sends an approval to the acquirer 120 and a reimbursement less a fee of $0.17. The acquirer 120 then sends an approval to the merchant 110 less the $0.17 fee. Of the $100 payment amount, the merchant 110 receives $98.07. The issuer 140 then bills the customer 100 by means of a statement which the customer 100 is obligated to pay under the terms of an agreement between the customer 100 and the issuer 140. As between the merchant 110 and the acquirer 120, data communications between the acquirer 120, the association 130 and the issuer 140 are conventionally carried over a wired network.

A conventional debit card transaction includes similar steps and parties as shown in FIG. 2. The association 130 is replaced by a regional network 230. In order to affect an exemplary purchase totaling $100 by a customer 200 from a merchant 210 using a debit card, the transaction is submitted to an acquirer 220 by the merchant 210 including an authorization request. The submission process conventionally includes a data communication between the merchant 210 and the acquirer 220 using a wired network.

Upon receiving the submission from the merchant 210, the acquirer 220 submits the transaction to the regional network 230 which in turn submits the transaction to an issuer 240. Each transaction submission includes an authorization request. In the case where the issuer 240 approves the transaction and authorization request, the issuer 240 sends an approval to the regional network 230 and a reimbursement less a fee of $0.05. The reimbursement may be affected by means of an electronic funds transfer.

The regional network 230 in turn sends an approval to the acquirer 220 and a reimbursement less a fee of $0.09. The acquirer 220 then sends an approval to the merchant 210 less a fee of $0.19. Of the $100 payment amount, the merchant 110 receives $99.67. The issuer 240 then bills the customer 200 by means of a statement which the customer 200 is obligated to pay under the terms of an agreement between the customer 200 and the issuer 240. As between the merchant 210 and the acquirer 220, data communications between the acquirer 220, the association 230 and the issuer 240 are conventionally carried over a wired network.

The conventional methods shown in FIG. 1 and FIG. 2 suffer from several disadvantages. Data communications between the merchant 110, 210, the acquirer 120, 220, the credit card association 130, the regional network 230 and the issuer 140, 240 may be subject to piracy. Furthermore, not all customers wanting a credit or debit card are eligible to receive such a card. Bad credit and/or bankruptcy make some customers ineligible for credit. More importantly, payment cards are often lost or stolen presenting customers so affected with several concerns. Since the authorization only involves the credit card issuer 140, anyone with the correct card information can make transactions successfully without the knowledge of the customer card holder. This situation is more serious with online transactions where the customer needs to disclose his credit card information over the network to an online merchant with virtually no physical address. A malicious online merchant can charge the credit card without the customer's approval, or a weakly protected user database may be hacked thereby putting the customer's credit card information at risk.

Furthermore, customers whose payment cards are lost may not discover the loss until their cards have been used by an unauthorized finder of the lost card. Having discovered the loss, customers may not remember or be able to locate the contact telephone number for the payment card issuer 140, 240. Furthermore, customers may not remember their account number and other relevant identifying information including passwords.

As previously noted identity thieves are able in some cases to gain access to a customer's personal information including their payment card account numbers and other relevant information. This information may be pirated from the above identified data communications. This information may further enable identity thieves to freely use the customer's payment card, particularly if the thief has gained access to other identifying information such as the customer's billing address which is conventionally used to authenticate a payment card user.

Finally, merchants pay a high cost by accepting payment cards, particularly credit cards. In the example illustrated in FIG. 1, the merchant 110 receives only $98.07 of a $100 credit card payment. The merchant 210 receives $99.67 of the $100 debit card payment. Additionally, merchants 110 and 210 must purchase or lease special equipment adapted to submit transactions to acquirers 120 and 220. The combined service fees costs and equipment costs make the acceptance of payment cards by small merchants 110 and 120 impractical and too costly in many cases

Attempts to solve the many problems of the traditional payment card transaction system are many in the prior art. For example, a method of payment in an electronic payment system is disclosed in U.S. Pat. No. 6,029,150 wherein a plurality of customers have accounts with an agent. A customer obtains an authenticated quote from a specific merchant, the quote including a specification of goods and a payment amount for those goods. The customer sends to the agent a single communication including a request for payment of the payment amount to the specific merchant and a unique identification of the customer. The agent issues to the customer an authenticated payment advice based only on the single communication and secret shared between the customer and the agent and status information which the agent knows about the merchant and/or the customer. The customer forwards a portion of the payment advice to the specific merchant. The specific merchant provides the goods to the customer in response to receiving the portion of the payment advice. However, since the payment advice is encrypted and usually very long, a special electronic device is required in order to forward the payment advice to the merchant. The availability of the device limits the application of the disclosed method. Another problem is that the communication path is controlled by the customer, whom merchants may not fully trust. Therefore, a malicious customer can easily get a large number of samples of payment advices and more easily hack the encryption.

U.S. Patent Application Publication No. 2001/0007983 discloses an electronic monetary system comprising a mobile communication unit as an electronic wallet for transactions including electronic payments, money transfers, and recharging the electronic account. The security of the electronic transactions is confirmed by circulating a confirmation number through a loop formed by an e-wallet managing server through a wireless network to the mobile communication unit of the user. The disclosed method requires that the customer first provide an e-wallet number/password before the confirmation is issued by the server. This means that the web interface for the merchant needs to be changed in order to use the two-phase charge protocol, which is different from traditional credit card charging protocols.

A mobile payment system is disclosed in U.S. Patent Application Publication No. 2002/0073027 in which a method designed to facilitate payments and transactions in addition to credit and debit card payments includes (a) receiving a payment request in an operation center from a registered merchant through a communication network, (b) requesting the registered merchant, through the communication network, to inform a customer ID of a customer, who is a registered member of the operation center, and a transaction amount to be paid by the customer to the registered merchant, (c) verifying a merchant ID of the registered merchant by the operation center, (d) confirming the payment request by the operation center by notifying the customer and requesting for verification, (e) requesting the customer to verify the payment transaction by confirming the transaction amount and inputting a security password of the customer registered in the operation center, and (f) confirming with the registered merchant whether the payment request is issued. However, the disclosed method requires the customer to input a security password, which will prolong the transaction processing time. Moreover, the disclosed method is limited to fund transfers between merchant and customer, and is not suitable for fund transfers between individuals.

U.S. Patent Application Publication No. 2003/0018532 discloses a method for conducting mobile commerce by verifying user authorization at a hand held device. A transaction request is then transmitted from the hand held device. An amount and a transaction identification are transmitted from a base unit in response to the transaction request. The amount transmitted is displayed at the hand held device. A user identification and the transaction identification are then transmitted from the hand held device and a credit transaction is posted to the user identification from the base unit, as a function of the transaction identification. However, the transactions are initiated from the hand-held device, which is not the case for most supermarket check out scenarios.

A method and system for processing Internet payments using the electronic funds transfer network is disclosed in U.S. Pat. No. 6,609,113. The main structural components of the system include a Payment Portal Processor (PPP), an Internet Pay Anyone (IPA) Account, a Virtual Private Lockbox (VPL) and an associated Account Reporter, the existing EFT networks, and a cash card for accessing a VPL or IP account. The PPP is a software application that provides a secure portal for accessing (linking to) either the user's Demand Deposit Account (DDA) or an IPA account and can be combined with the functionality of a traditional digital Wallet. Consumers use a PPP enhanced Wallet to fund their account, shop on the web, pay bills, pay anyone, store electronic receipts and transaction history, and check their recent PPP enhanced Wallet activity. The IPA account is a special purpose account with limited functionality for making electronic payments in the form of EFT credit messages. The VPL is a limited function receive only account for receiving electronic payments through the EFT. The Account Reporter is a portal to view transaction history and balance of IPA and VPL accounts, provide online, real-time transaction reports, and to reconciles accounts receivable/purchase records against incoming EFT payment records. A physical card can be associated with either an IPA or VPL account in order to provide PIN debit capability. However, the disclosed method and system are designed for internet commerce only. Similar to traditional credit card transactions, since the user does not participate in the authorization process, if the user looses the account and password for IPA or VPL accounts, the security of the system is breached.

U.S. Pat. No. 0,675,5342 describes an apparatus and method for validating a credit card over a wireless network includes a gateway for sending a credit card validation reply message to a wireless device in response to receiving a credit card validation request message from the wireless device, the request message including credit card information for identifying a credit card to be validated. The method includes sending a first credit card validation request message to a gateway from a wireless device, the first request message including credit card information for identifying a credit card to be validated; sending a second credit card validation request message and the credit card information from the gateway over an external network in communication with the gateway to a credit card validation service provider for processing the credit card information; receiving by the gateway a first credit card validation reply message from the credit card validation service provider over the external network; and sending a second credit card validation reply message from the gateway to the wireless device. However, the disclosed method only encapsulates the credit card information with wireless messages, and does not include credit card holders in the authorization process. Therefore, it cannot effectively prevent fraudulent use of a customer's credit card information.

A method and system for performing a financial transaction in a mobile communications system is disclosed in U.S. Patent Application Publication No. 2004/0243490. To enable diversified financial transactions between the originator and the recipient of the transaction, a first transaction message is sent to a transaction server and then processed. In response to the processing, a second and a third transaction message are generated. The second transaction message includes information required for performing the transaction in respect of the first mobile network subscriber, and the third transaction message includes information required for performing the transaction in respect of the recipient of the transaction. The second transaction message is sent to a first mobile network billing centre for settling the transaction with respect to the first mobile network subscriber, and the third transaction message is sent to a system receiving the transaction for settling the transaction with respect to the recipient. When applied to credit card transactions, the disclosed method is similar to traditional credit card processing procedures, which do not involve the card holder during the authorization step and can not prevent fraudulent usage of credit card information.

U.S. Patent Application Publication No. 2005/0033684 discloses methods and systems for performing sales transactions using a mobile communications device and without requiring text messaging or paging services. In one example, a subscriber desiring to purchase goods or services proceeds to a point of sale device where the purchase price for the goods or services is totaled. The subscriber then initiates a voice call with a central transaction server. The subscriber provides a point of sale device identifier and the purchase price to the central transaction server. The central transaction server contacts a local transaction server using the identifier provided by the subscriber. The central transaction server also prompts the subscriber to select the payment account for the transaction and verifies that the subscriber has sufficient credit to purchase the goods or services. The central transaction server locates a pending transaction entry in a database local to the point of sale using the device identifier provided by the subscriber. Upon locating the pending transaction entry and verifying that the subscriber has sufficient credit, the central transaction server notifies the subscriber and the point of sale device that the transaction is complete. The disclosed method uses voice call to initiate a transaction. However, voice recognition is known to be unreliable for complicated messages. Therefore, several levels of confirmation are required in the process greatly prolonging the transaction time. As a result, the check out time using the disclosed method will be much longer than traditional credit card authorization processes.

As demonstrated by the activity in the prior art, mobile devices are increasingly being used to transact business in mobile networks, a usage often referred to as m-commerce. This trend is being spurred by the rapid growth of mobile device use which in some parts of the world is outstripping the use of payment cards. Groups including the Mobile Payment Forum and the Mobey Forum seek to standardize the features and functions needed for simple, secure and authenticated mobile payments. Contemplated solutions include the dual chip solution in which a mobile handset is equipped with an additional chip card including one or more applications. The chip card is issued by a bank or another trusted third party. The dual slot solution involves the consumer having multiple cards in their possession and the handset is equipped with a full-size card reader. The SIM/WIM solution refers to a concept where the bank-issued security credentials are stored on a network operator issued SIM card. Finally, software/hardware based concepts include storing security credentials in the phone memory

Known solutions to the problem of securing financial transactions executed over networks are typically complex and involve the development of specialized equipment and complex protocols. These solutions are therefore expensive to implement while not completely eliminating the opportunity for fraud to be perpetrated against consumers using financial products such as credit and debit cards.

There is therefore a need in the art for a system and method for securely making payment and deposits that overcomes the disadvantages of the prior art. What is needed is a system and method that provides security and is easy to implement. What is also needed is a system and method that is less costly than existing systems and methods. Moreover, what is needed is a system and method that relies on existing technology to provide security to financial transactions. In addition, what is needed is a system and method that easily authenticates the customer making the financial transaction. Furthermore, what is needed is a system and method capable of handling high transaction volumes.

### SUMMARY OF THE INVENTION

The present invention overcomes the disadvantages of the prior art by providing in exemplary embodiments, a system and method for making payments and deposits wherein an authorization for a financial transaction may be provided by a person making the financial transaction using a securely identifiable device. Securely identifiable devices such as cell phones are not as easily misplaced and/or stolen as are payment cards and are therefore more reliable as devices capable of being used to authorize financial transactions. Furthermore, owners of such securely identifiable devices generally discover their loss or theft before discovering the loss or theft of payment cards. The present invention makes use of these well known realities to utilize securely identifiable devices as further described herein.

In accordance with an aspect of the invention, a method for securely and synchronously making a payment includes the steps of submitting a transaction request to a transaction center, the transaction request including details of a transaction between a customer and a third party involving the payment, confirming the transaction request with the customer by communicating with the customer on a customer securely identifiable device, submitting the transaction request for approval, and paying the third party.

In accordance with yet another aspect of the invention, a method of securely and synchronously making a deposit includes the steps of submitting a deposit request from a depositor to a transaction center, confirming an deposit request with the depositor by communicating with the depositor on a depositor securely identifiable device, receiving an authorization from the depositor, and depositing a deposit amount in a third party receiver account.

In accordance with another aspect of the invention, a method of securely and asynchronously making a payment includes the steps of submitting a pre authorization request to a transaction center, the pre authorization request including details of a transaction between a customer and a third party, confirming the pre authorization request with the customer by communicating with the customer on a customer securely identifiable device, notifying the third party of the confirmation, receiving a request from the third party, approving the request, submitting the approved request to a financial network for approval, and making payment to the third party.

In accordance with yet another aspect of the invention, q method of securely and asynchronously making a deposit includes the steps of submitting a deposit pre authorization request from a depositor to a transaction center, confirming the deposit pre authorization request with the depositor, receiving a pre authorization from the depositor, notifying a third party receiver of the deposit of the pre authorization, receiving a request for a deposit amount from the third party receiver, verifying the request for the deposit, requesting a funds transfer, and depositing the deposit amount in a third party receiver account.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended herein.

In this respect, before explaining at least one embodiment of the invention in detail, it is to be understood that the invention is not limited in its application to the details of design and to the sequence of steps and processes set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other methods and systems for carrying out the several purposes of the present invention. It is important, therefore, that the claims be regarded as including such equivalent methods and systems insofar as they do not depart from the spirit and scope of the present invention.

### BRIEF DESCRIPTION OF THE DRAWINGS

The present disclosure may be better understood and its numerous features and advantages made apparent to those skilled in the art by referencing the accompanying drawings.

FIG. 1 is a flow chart of a prior art credit card transaction;

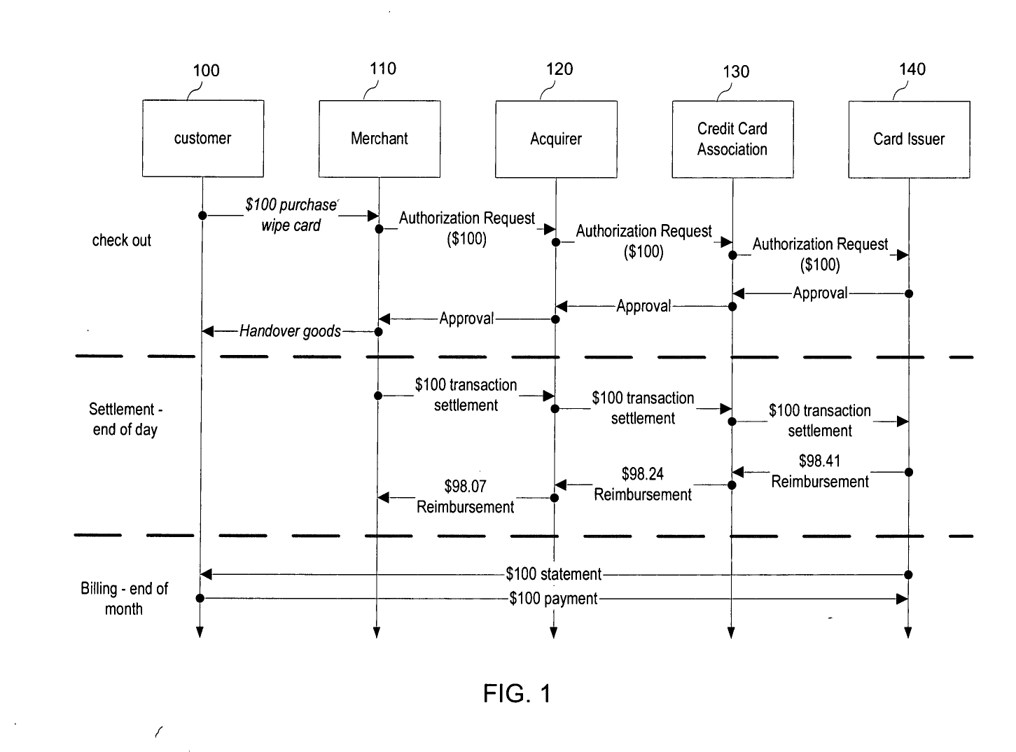

FIG. 2 is a flow chart of a prior art debit card transaction;

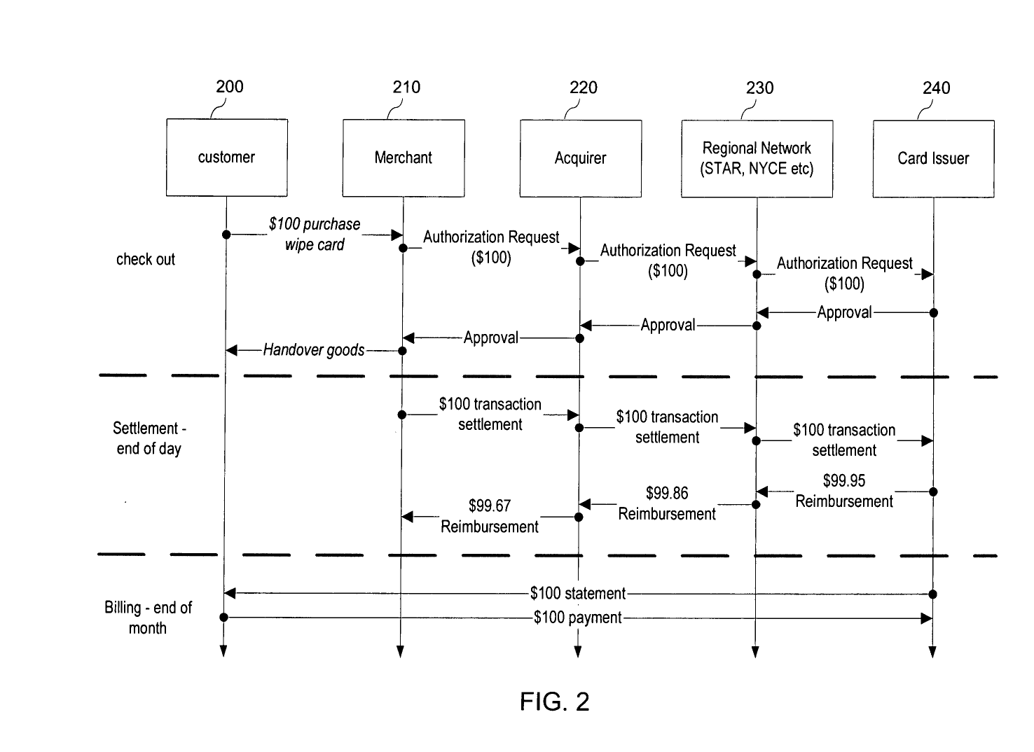

FIG. 3 is a flow chart of a method of securely and synchronously making a payment using a payment card in accordance with the invention;

FIG. 4 is a flow chart of a method of securely and synchronously making a deposit in accordance with the invention;

FIG. 5 is a flow chart of a method of securely and asynchronously making a payment using a payment card in accordance with the invention; and

FIG. 6 is a flow chart of a method of securely and asynchronously making a deposit in accordance with the invention.

### DETAILED DESCRIPTION OF THE INVENTION

The present invention may be implemented using known computing devices and distributed networks. Certain features of the invention may be implemented in a server machine or distributed across a plurality of server machines. Methods in accordance with the present invention may be implemented in computer-readable media operable to instruct computing devices to perform method steps. Systems in accordance with the present invention may include computing devices operable to perform method steps.

In accordance with an aspect of the invention, an authorization for a financial transaction may be provided by a person making the financial transaction using a securely identifiable device. The securely identifiable device may have a device identification which is hardware based and securely identifiable. More specifically, the device should be able to identify itself at a hardware level so that the device identification cannot be fraudulently acquired. Moreover, the device identification may be controlled by an authority and there may be some form of association between the device identification and the individual to whom the securely identifiable device is assigned by the authority. In other words, there is no anonymity in the identification. For example, the security architecture of the GSM and CDMA wireless architectures effectively prevent the fraudulent use of the device identification and the assigned cell phone numbers are carefully controlled by wireless service providers. Thus a cell phone using the GSM or CDMA wireless protocols is said to be securely identifiable. On the other hand, internet IP addresses, or Ethernet card mac addresses are not controlled in the same manner. Therefore systems based on internet IP addresses and Ethernet card mac addresses as identification do not qualify as securely identifiable devices.

The securely identifiable device may further include a desktop computer together with a wired POTS or VoIP telephone. The desktop computer may have installed thereon a client software application which maintains a session log to keep the customer's identification valid while a customer completes a financial transaction. The customer's identification may be established by making a call to the customer's POTS or VoIP telephone from a service center (hereinafter referred to as ezMobilePay) and providing a random passcode to the client software application. Since the POTS or VoIP telephone is securely identifiable, the desktop computer and the POTS or VoIP telephone together provide a securely identifiable device.

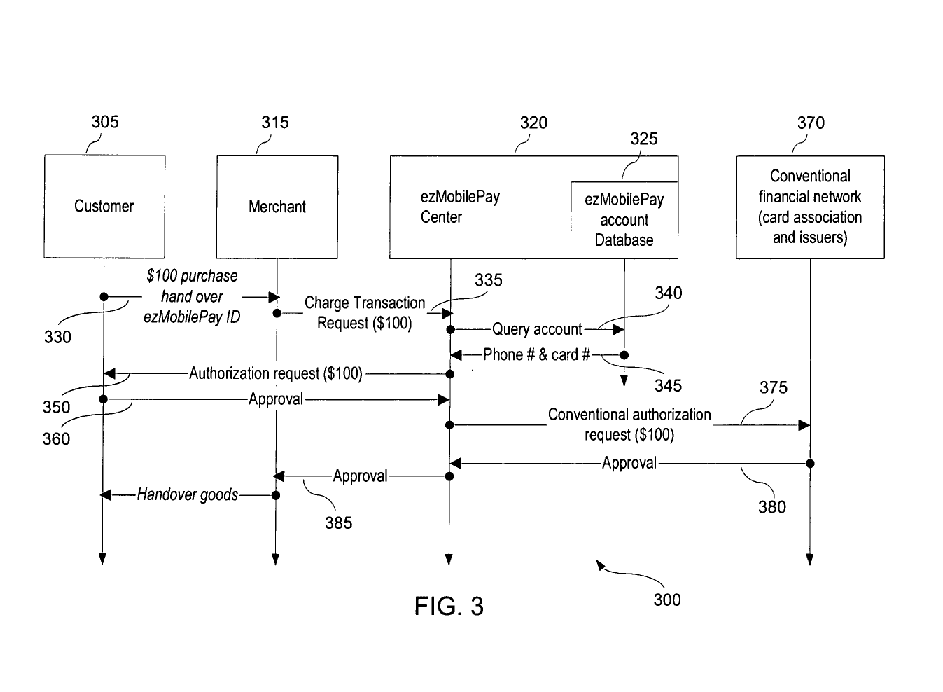

With reference to FIG. 3, a method for securely and synchronously making a payment using a payment card generally designated 300 is shown. Methods in accordance with the invention, including method 300 presuppose that a user or customer wishing to make a payment using a payment card has an agreement with the ezMobilePay service provider (EPC), the terms of which establish a user account and associate the user's securely identifiable device with the user's account. The user account may include user information such as payment card account number, bank account information, password, mailing address and billing address. The user account may have associated therewith a ezMobilePay identification.

Method 300 may be implemented at a check out time when for example a customer 305 is making a $100 purchase from a merchant 315 at a cashier or other point of sale using a payment card. In a step 330 the customer 305 may provide the merchant 315 with the ezMobilePay identification. In a step 335 the merchant 315 may send a charge transaction request to an ezMobilePay center 320. The charge transaction request may be sent over a computer network (not shown) or over a leased line (not shown). The charge transaction request may include a payment amount, the customer's ezMobilePay identification, a merchant identification and other control information. In a step 340 an ezMobilePay center database 325 may be queried and in a step 345 the device identification and/or device phone number of the customer's securely identifiable device may be returned to the ezMobilePay center 320. An authorization request message may be sent to the customer in a step 350 using the device identification. Step 350 may include a forwarding step (not shown) in which a wireless carrier is utilized in the case where the securely identifiable device is a wireless telephone. The customer 305 may approve the transaction in a step 360 and notify the ezMobilePay center 320 of the approval by means of the customer's wireless telephone or PC client coupled with POTS or VoIP telephone.

The payment card may be a credit card or debit card issued by a credit card issuer in which case, upon the customer's approval of the transaction in step 360, conventional steps 375 (authorization) and 380 (approval) may be taken by the ezMobilePay center 320 to complete the transaction with conventional financial networks 370. In a step 385 the ezMobilePay center 320 may approve the transaction. Alternatively, the payment card may be used to draw from a customer account held by a third party such as the wireless carrier. Additionally, the payment card may be used to draw from a customer account held by the ezMobilePay center 320.

As will be appreciated by those skilled in the art, method 300 provides a secure and cost effective way of ensuring secure and synchronous payments using payment cards. No additional equipment is required of the customer. Advantageously, method 300 utilizes securely identifiable devices such as wireless telephones which are rapidly becoming ubiquitous. Furthermore, while the prior art provides for a securely identifiable scheme which may include a username/password combination, method 300 provides security which is hardware based and securely identifiable.

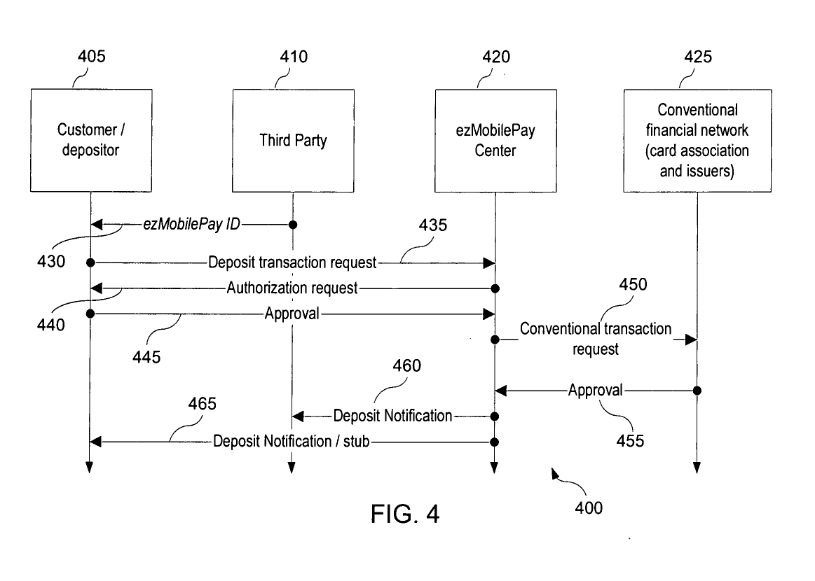

In another aspect of the invention, a method for securely and synchronously making deposits generally designated 400 is shown in FIG. 4. A customer or depositor 405 having an account with an ezMobilePay center 420 may wish to make a deposit to an account of a third party 410 having an account with the ezMobilePay center 420. In a step 430 the third party 410 may provide the depositor 405 with identifying information including the third party's ezMobilePay center account information. In a step 435 the depositor 405 may make a deposit request to the ezMobilePay center 420 by means of a securely identifiable device. Such a deposit request may include the amount of the deposit, the third party's ezMobilePay center account information, and other details of the transaction. In a step 440 the ezMobilePay center 420 may send the depositor 405 an authorization request. Such a request may include a call to the depositor's securely identifiable device. The depositor 405 may approve or disapprove of the transaction. If the depositor disapproves of the transaction the method 400 ends. Otherwise, in a step 445 the depositor 405 may approve the transaction. In a step 450 a transaction request may be sent to a conventional financial network 425 and in a step 455 the conventional financial network 425 may approve the transaction. The deposit may be made to the third party's account in a step 460 and notification sent to the depositor in a step 465.

Methods 300 and 400 may be accomplished in a synchronous manner. It is contemplated that the customer 305 and depositor 405 are contemporaneously available to receive the authorization request from the ezMobilePay center 320, 410 and to quickly communicate the authorization to the ezMobilePay center 320, 410. However, for certain transactions, such as online transactions in which the customer 305 may not be billed until the item purchased is shipped, the customer may not be available to authorize the transaction. In methods 500 and 600 described below, transactions may be processed asynchronously. The asynchrony may be divided into two categories. In a first category, the customer or third party and the merchant or depositor need not be contemporaneously available. In a second category, the actual fund transfer does not necessarily happen immediately after the customer's or depositor's authorization.

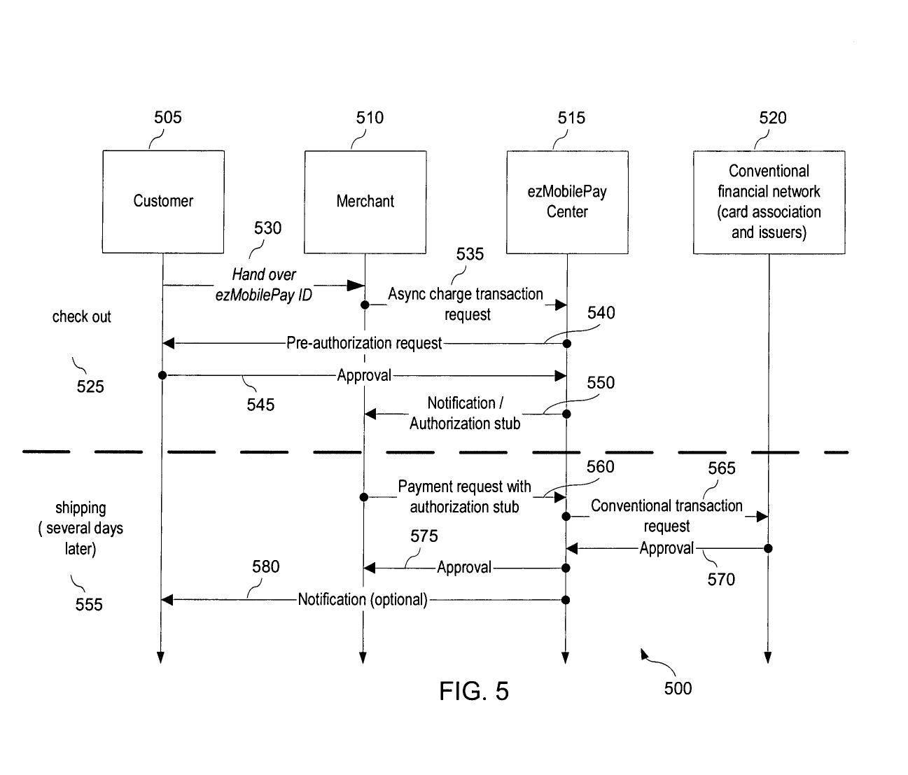

In accordance with another aspect of the invention, a method for securely and asynchronously making a payment using a payment card generally designated 500 is shown in FIG. 5. In a step 530 at a check out time 525, a customer 505 may provide a merchant 510 with the customer's ezMobilePay identification. In a step 535 the merchant 510 may send an ezMobilePay center 515 a asynchronous charge transaction request including details of a transaction between the customer 505 and the merchant 510. The ezMobilePay center 515 may send the customer 505 an pre-authorization request in a step 540. Such a request may include a call to the customer's securely identifiable device. The customer 505 may approve or disapprove of the transaction. If the customer disapproves of the transaction, the method 500 ends. If the customer 505 approves of the transaction, the approval may be communicated to the ezMobilePay center 515 in a step 545. The ezMobilePay center 515 may send the merchant 510 a preauthorization stub in a step 550. The preauthorization stub may include a unique encrypted string generated by the EPC 515.

At the time 555 that the merchant 510 requires a settlement of the financial transaction, such as when the purchased items are sent to the customer 505, a settlement notice may be sent to the ezMobilePay center 515 in a step 560. The settlement notice may include the customer's identification number, the merchant's identification number, the amount of the transaction and the pre authorization stub. The ezMobilePay center 515 may verify the authenticity of pre authorization stub. If the pre authorization stub is not verified, the merchant may be notified of this action. Otherwise, an authorization request may be sent to the payment card issuer or other third party 520 having an account with the customer 505 in a step 565. In a step 570 the payment card issuer or other third party 520 may approve or disapprove the authorization request. If the authorization request is disapproved, the merchant 510 is notified and the method 500 ends. Otherwise, a reimbursement is made to the merchant 510 in a step 575. A notification may be optionally sent to the customer 505 in a step 580.

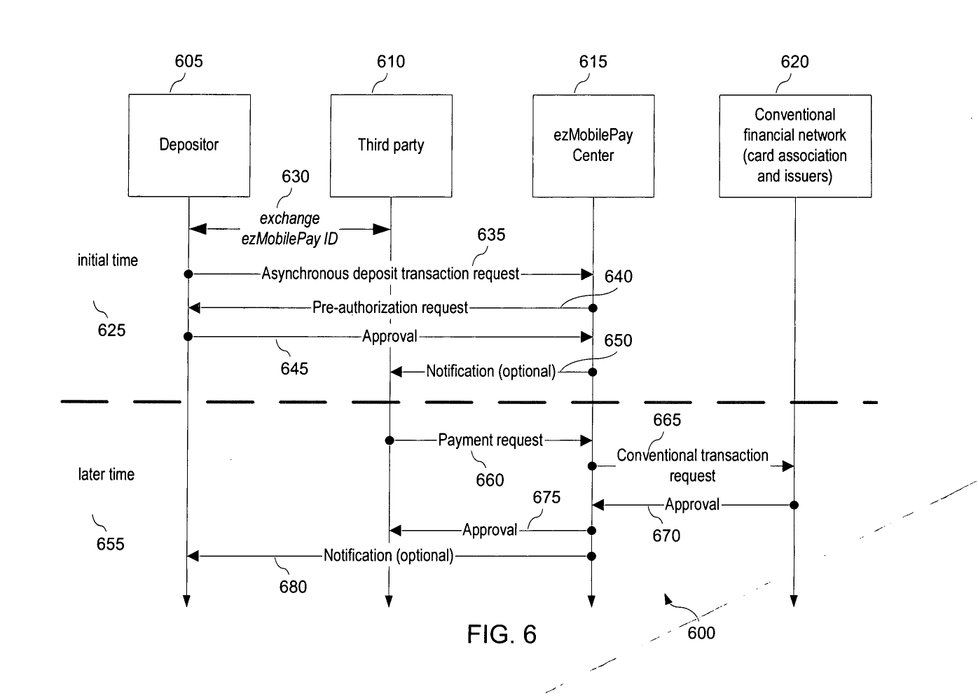

In another aspect of the invention, a method for securely and asynchronously making a deposit generally designated 600 is shown in FIG. 6. At an initial time 625, in a step 630 a depositor 605 having an account with an ezMobilePay center 615 may exchange identifying information with a third party recipient 610 having an account with the ezMobilePay center 615. A deposit transaction may be initiated by the depositor 605 in a step 635 by sending the ezMobilePay center 615 a pre authorization request including the depositor's identification number, identifying information concerning the third party recipient 610 such as the third party's ezMobilePay account number, the amount of the deposit, an expiration date, and an annotation. The ezMobilePay center 615 may confirm the pre authorization with the depositor 605 in a step 640. Such a confirmation may include a call to the depositor's securely identifiable device. The depositor 605 may confirm the transaction in a step 645. In a step 650 the ezMobilePay center 615 may optionally notify the third party recipient 610 of the depositor's pre authorization.

The third party recipient 610 may at a later time 655 request that the deposit be made in a step 660. Such a request may include the depositor's identification number, the third party recipient's ezMobilePay identification number and the amount of the deposit. The ezMobilePay center 615 may either approve or disapprove of the transaction by checking the information in the third party recipient request against the information in the pre authorization. If the transaction is disapproved, the recipient is notified and the method 600 ends. Otherwise, the ezMobilePay center 615 may request that a financial institution 620 deposit the funds in the recipient's account in a step 665. The financial institution may approve or disapprove of the transaction in a step 670. If the transaction is disapproved the method 600 ends. Otherwise, the funds may be deposited in the third party recipient's account in a step 675 and the depositor optionally notified in a step 680.

The methods of the invention provide security by providing for direct customer or depositor participation in the authorization process. Customer identification may be based on both identifying information such as passwords and physical possession of the securely identifiable device. In addition, the methods of the invention provide for both synchronous and asynchronous transactions without requiring a card reader. A plurality of devices may serve as the client securely identifiable device and a plurality of networks may be employed in communications between the client device and the EPC.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A method for securely and synchronously making a payment comprising the steps of:
submitting a transaction request to a transaction center, the transaction request including details of a transaction between a customer and a third party;
confirming the transaction request with the customer by communicating with the customer on a customer securely identifiable device;
submitting the transaction request for approval; and
paying the third party.

2. The method of claim 1, wherein the customer and the third party each have an agreement with the transaction center, the customer agreement associating a customer securely identifiable device identification number with a customer payment card.

3. The method of claim 2, wherein the customer securely identifiable device comprises a wireless telephone and the customer securely identifiable device identification number comprises a phone number associated with the wireless telephone.

4. The method of claim 2, wherein the customer securely identifiable device comprises a desktop computer and a wired telephone and the customer securely identifiable device identification number comprises a phone number associated with the wired telephone.

5. The method of claim 1, wherein the securely identifiable device comprises a device having a device identification that is hardware based, that cannot be fraudulently acquired and is controlled by an authority.

6. A method of securely and synchronously making a deposit comprising the steps of:
submitting a deposit request from a depositor to a transaction center;
confirming an deposit request with the depositor by communicating with the depositor on a depositor securely identifiable device;
receiving an authorization from the depositor; and
depositing a deposit amount in a third party receiver account.

7. The method of claim 6, wherein the depositor has an agreement with the transaction center, the depositor agreement associating a depositor securely identifiable device identification number with a depositor account.

8. The method of claim 7, wherein the depositor securely identifiable device comprises a wireless telephone and the depositor securely identifiable device identification number comprises a phone number associated with the wireless telephone.

9. The method of claim 7, wherein the depositor securely identifiable device comprises a desktop computer and a wired telephone and the depositor securely identifiable device identification number comprises a phone number associated with the wired telephone.

10. The method of claim 6, wherein the securely identifiable device comprises a device having a device identification that is hardware based, that cannot be fraudulently acquired and is controlled by an authority.

11. A method of securely and asynchronously making a payment comprising the steps of:
submitting a pre authorization request to a transaction center, the pre authorization request including details of a transaction between a customer and a third party;
confirming the pre authorization request with the customer by communicating with the customer on a customer securely identifiable device;
notifying the third party of the confirmation;
receiving a request from the third party;
approving the request;
submitting the approved request to a financial network for approval; and
making payment to the third party.

12. The method of claim 11, wherein the customer and the third party each have an agreement with the transaction center, the customer agreement associating a customer securely identifiable device identification number with a customer payment card.

13. The method of claim 12, wherein the customer securely identifiable device comprises a wireless telephone and the customer securely identifiable device identification number comprises a phone number associated with the wireless telephone.

14. The method of claim 12, wherein the customer securely identifiable device comprises a desktop computer and a wired telephone and the customer securely identifiable device identification number comprises a phone number associated with the wired telephone.

15. The method of claim 11, wherein the securely identifiable device comprises a device having a device identification that is hardware based, that cannot be fraudulently acquired and is controlled by an authority.

16. A method of securely and asynchronously making a deposit comprising the steps of:
submitting a deposit pre authorization request from a depositor to a transaction center;
confirming the deposit pre authorization request with the depositor;
receiving a pre authorization from the depositor;
notifying a third party receiver of the deposit of the pre authorization;
receiving a request for a deposit amount from the third party receiver;
verifying the request for the deposit;
requesting a funds transfer; and
depositing the deposit amount in a third party receiver account.

17. The method of claim 16, wherein the depositor has an agreement with the transaction center, the depositor agreement associating a depositor securely identifiable device identification number with a depositor account.

18. The method of claim 17, wherein the depositor securely identifiable device comprises a wireless telephone and the depositor securely identifiable device identification number comprises a phone number associated with the wireless telephone.

19. The method of claim 17, wherein the depositor securely identifiable device comprises a desktop computer and a wired telephone and the customer securely identifiable device identification number comprises a phone number associated with the wired telephone.

20. The method of claim 16, wherein the securely identifiable device comprises a device having a device identification that is hardware based, that cannot be fraudulently acquired and is controlled by an authority.
